(19) United States
(12) Patent Application Publication
(10) Pub. No.: US 2025/0306439 A1
(43) Pub. Date: Oct. 2, 2025

(54) CAMERA GRIP AND CAMERA AUXILIARY DEVICE

(71) Applicant: TILTA INC., Burbank, CA (US)

(72) Inventors: Sen WU, Shenzhen (CN); Hong ZHANG, Shenzhen (CN); Wenping ZENG, Shenzhen (CN); Kefeng ZHOU, Shenzhen (CN)

(21) Appl. No.: 19/072,569

(22) Filed: Mar. 6, 2025

(30) Foreign Application Priority Data
Apr. 2, 2024 (CN) 2024206943200

(51) Int. Cl. G03B 17/56

(52) U.S. Cl. CPC G03B 17/563; G03B 17/561

(57) ABSTRACT

The present disclosure introduces a camera grip and a camera auxiliary device to address the issues of adjusting the position of photographic equipment on the camera grip. The camera grip includes a grip body, a connecting arm, and a locking component. The grip body is fitted with a guide rail. The connecting arm has a first end and a second end, with the first end mounted on the guide rail and movable along the guide rail, and the second end configured for attaching photographic equipment. The locking component is located at the first end of the connecting arm. In the unlocked position, the connecting arm can slide along the guide rail; when in a locked position, the connecting arm is fixed on the guide rail.

### CROSS-REFERENCE TO RELATED APPLICATIONS

The present application for patent claims priority to and the benefit of pending Chinese Application No. 2024206943200, filed Apr. 2, 2024, and hereby expressly incorporated by reference herein as if fully set forth below in its entirety and for all applicable purposes.

### TECHNICAL FIELD

The present application pertains to the technical field of auxiliary tools for photographic equipment, specifically addressing a camera grip and a camera auxiliary device.

### INTRODUCTION

Camera grips are widely utilized as auxiliary accessories in photographic equipment. Photographers often need to adjust the position of the photographic equipment on the grip during the shooting process to accommodate different shooting compositions or personal preferences, achieving a more comfortable grip. However, current camera grips lack the functionality to adjust the position of the photographic equipment on the camera grip.

### BRIEF SUMMARY

The present disclosure provides a camera grip and a camera auxiliary device, designed to resolve the technical challenge of adjusting the position of the photographic equipment on the camera grip.

According to a first aspect of the present application, an embodiment presents a camera grip including:
a grip body equipped with a guide rail;
a connecting arm featuring a first end and a second end, where the first end is situated on the guide rail and can move along the guide rail, and the second end is configured to connect to photographic equipment; and
a locking component positioned at the first end of the connecting arm,
when the locking component is unlocked, the connecting arm can slide along the guide rail; and when the locking component is locked, the connecting arm is secured in place on the guide rail.

### BRIEF DESCRIPTION OF THE DRAWINGS

FIG. 1 is a diagram illustrating a camera auxiliary device according to some aspects of the disclosure;

FIG. 2 is a diagram illustrating a camera grip shown in FIG. 1;

FIG. 3 is a diagram illustrating a perspective view of the camera grip of FIG. 2;

FIG. 4 is a diagram illustrating a cross-sectional diagram of the camera grip of FIG. 2;

FIG. 5 is a diagram illustrating an exploded diagram of a grip body in the camera grip according to some aspects of the disclosure;

FIG. 6 is a diagram illustrating an exploded diagram of a connecting arm in the camera grip according to some aspects of the disclosure;

FIG. 7 is a diagram illustrating the force between a connector and a detachable member according to some aspects of the disclosure;

FIG. 8 is a diagram illustrating a perspective view of a connector of FIG. 6;

FIG. 9 is a diagram illustrating the cooperation between a limiting part and a limiting groove according to some aspects of the disclosure.

### REFERENCE NUMBER LIST

1—Camera auxiliary device; 2—Shooting device; 100—Camera grip; 200—Camera accessory; 10—Grip; 11—Guide rail; 11—Slide groove; 12—Accommodating chamber; 13—Operation groove; 14—Avoidance groove; 15—Non-slip gasket; 16—Seal sheet; 17—Mounting hole; 18—Extension interface; 20—Connecting arm; 21—Connector; 210—Connecting hole; 211—First coupling end; 212—Second coupling end; 22—Detachable member; 23—Limiting button; 24—Limiting assembly; 241—Limiting part; 242—Elastic member; 243—Limiting groove; 25—Second threaded rod; 30—Locking component; 31—Locking member; 32—First threaded rod; 320—Nut; 33—Brace; 34—Retention collar.

### DETAILED DESCRIPTION

The present application is further elaborated upon through specific examples in conjunction with the drawings. Similar components across different examples are assigned with corresponding reference labels. In the following examples, detailed descriptions are provided to facilitate a better understanding of the present application. However, those skilled in the art can readily recognize that some features can be omitted in various scenarios or replaced with alternative components, materials, or methods. In some instances, certain operations related to the present application are not explicitly shown or described in the specification to maintain focus on the core aspects of the present application. Nevertheless, those skilled in the art will readily understand these operations based on the disclosure provided herein and their general technical knowledge in the field.

Additionally, features, operations, or characteristics described herein may be combined in any suitable manner into various aspects, and the operational steps involved in each embodiment may be rearranged or adjusted in a manner readily apparent to those skilled in the art. Therefore, the specification and drawings are only intended to describe an exemplary embodiment clearly and do not imply the necessary composition and/or sequence.

In this disclosure, the serial terms assigned to components, such as “first”, “second”, etc., are used only to distinguish the described objects and do not imply any specific order or technical significance. The terms “connection” and “linking”, unless otherwise specified, encompass both direct and indirect connections or links.

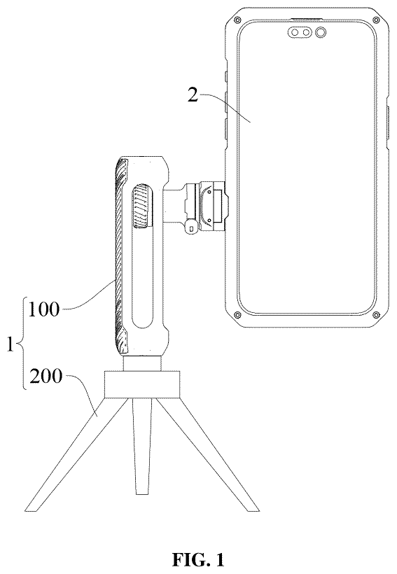

The present disclosure presents a camera auxiliary device 1, illustrated in FIG. 1. The camera auxiliary device may include a camera grip 100 and a camera accessory 200, and the camera grip 100 and the camera accessory 200 can be interconnected. The connection between the camera grip 100 and the camera accessory 200 can be either fixed or detachable, such as a threaded, plug-in, or snap-fit connection. The present disclosure does not imply any specific restrictions on the connection method between the camera grip 100 and the camera accessory 200. The camera grip 100 is designed to hold a shooting device 2, facilitating photography. Depending on the shooting scenario, the shooting device 2 can be a mobile phone, camcorder, tablet, camera, or other devices. The camera accessory 200 can encompass equipment like a tripod, hand strap, extension pole, flash, etc. The present disclosure is not limited to specific types of the shooting device 2 and the camera accessory 200.

During shooting, photographers often need to adjust the position of the shooting device 2 on the camera grip to suit different compositions or personal preferences, enhancing grip comfort. For instance, when shooting close-ups, photographers may prefer the shooting device 2 to be near the grip's handle for easier framing and stability. In underslung grip shooting, the shooting device 2 may need to be farther from the handle for ease of carrying and flexibility. However, current grips do not allow for adjustable positioning of the shooting device.

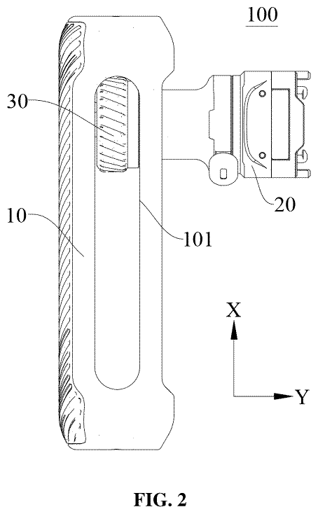

To address this, the present disclosure introduces a camera grip 100, for example, depicted in FIG. 2. The camera grip 100 may include a grip body 10, a connecting arm 20, and a locking component 30. The grip body 10 is equipped with a guide rail 11. The connecting arm 20 has a first end and a second end, with the first end attached to and movable along the guide rail 11. The second end of the connecting arm 20 is designed to connect with the shooting device 2 (e.g., as shown in FIG. 1). The locking component 30 is mounted on the first end of the connecting arm 20. When the locking component 30 is unlocked, the connecting arm 20 can slide along the guide rail 11; when the locking component 30 is locked, the connecting arm 20 is secured on the guide rail 11.

By equipping the grip body 10 with a guide rail 11 and mounting the first end of the connecting arm 20 onto the guide rail 11, the connecting arm 20 can move along the guide rail 11. Photographers can adjust the connecting arm 20 to any position on the grip body 10 along the guide rail 11, according to specific needs, enhancing the comfort of holding the grip body 10. Prior to adjustment, photographers unlock the locking component 30 in order to adjust the connecting arm 20. Once the desired adjustment is achieved, they can lock the locking component 30 to secure the connecting arm 20 on the guide rail 11, facilitating adjustable positioning of the shooting device 2 on the grip body 10. The camera grip 100 introduced by the present disclosure not only allows for adjustable positioning of the shooting device 2 on the grip 10 but also enables easy operation.

For instance, in shooting scenarios requiring extended video recording, the camera accessory 200 can be a tripod, with the connecting arm 20 linking the shooting device 2 and being fixed in the middle or near the bottom of the grip body 10 to lower the center of gravity of the camera accessory 200. In other scenarios, when photographers need to hold the camera for shooting, they can unlock the locking component 30 to adjust the shooting device 2 and then re-lock the locking component 30 to fix the shooting device 2 at or near the top of the grip body 10, facilitating easier handling.

In some aspects, the guide rail 11 can be either a guide groove on the grip body 10 or a guide rail protruding from the surface of the grip body 10. The present disclosure does not imply restrictions on the specific structural form of the guide rail 11 on the grip body 10. In some examples, the unlocking or locking of the locking component 30 can be achieved through actions such as rotating a knob, pressing a button, or engaging a damping limiter. The present disclosure does not limit the method for unlocking or locking the locking component 30.

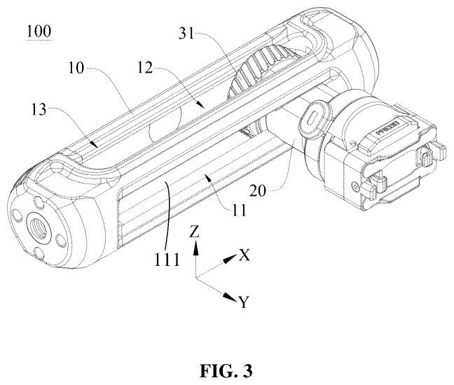

In some aspects, as illustrated in FIGS. 2 and 3, the guide rail 11 includes a slide groove mounted on the grip body 10, with the first end of the connecting arm 20 slidably mounted within the slide groove 111. When the locking component 30 is unlocked, the connecting arm 20 can slide along the slide groove 111. The locking component 30 may feature a locking member 31, with the first end of the connecting arm 20 connected to the locking member 31. Locking member 31 controls the unlocking and locking of the locking component 30.

In some aspects, the slide groove 111 guides the movement of the connecting arm 20, enabling the connecting arm 20 to adjust its position on the grip body 10 by sliding within the slide groove 111. Photographers can unlock or lock the locking component 30 by controlling the locking member 31, facilitating easy adjustments.

The grip body 10 has a length direction, a width direction, and a thickness direction. For example, the grip body 10 can be designed as a cylindrical structure, a bar structure, or a tubular structure. The present disclosure does not imply any specific shape of the grip body 10. For clarity in the following aspects, as shown in FIGS. 2 and 3, the X-direction represents the length direction of the grip body 10, the Y-direction represents the width direction, and the Z-direction represents the thickness direction. Thus, the connecting arm 20 can slide in the X-direction and can be connected to the grip body 10 in the Y-direction. In this disclosure, hollow components and features like holes and grooves are annotated with arrowed leader lines, as shown in FIG. 3, while other components use leader lines without arrows. This annotation method persists in subsequent drawings and will not be reiterated.

In some aspects, as depicted in FIG. 3, an accommodating chamber 12 may be provided inside the grip body 10. A slide groove 111 may be arranged on the side wall of the grip body 10 and connected to the accommodating chamber 12, with the locking member 31 slidably mounted within the accommodating chamber 12. An operation groove 13, connected to the accommodating chamber 12, may also be opened on the side wall of the grip body 10, with at least a portion of the locking member 31 exposed outside the operation groove 13.

Housing the locking member 31 within the accommodating chamber 12 of the grip body 10 can prevent the locking member 31 from getting lost. For example, if the locking member 31 inadvertently detaches from the connecting arm 20, the locking member 31 falls into the accommodating chamber 12, preventing loss. Furthermore, having at least a portion of the locking member 31 exposed outside the operation groove 13 allows photographers to easily operate the locking member 31. For instance, when the locking member 31 features a knob structure, two operation grooves 13 can be arranged on the grip body 10 along the rotational surface of the locking member 31 to facilitate rotation. Additionally, anti-slip patterns can be applied to the surface of the locking member 31 to enhance the tactile feel during rotation. When the locking member 31 adopts a button structure, only one operation groove 13 may be provided on the grip body 10. The present disclosure does not imply any specific number of operation grooves 13 on the grip body 10.

As an example, FIG. 3 illustrates that the accommodating chamber 12 on the grip body 10 can extend along the X-direction. Two operation grooves 13, also aligned along the X-direction, are respectively located on the side walls of the grip body 10, flanking the slide groove 111. The locking member 31 can feature a knob design, with the outer contour protruding from the two operation grooves 13. This design allows photographers to effortlessly rotate the locking member 31 using their fingers. Additionally, it facilitates sliding the locking member 31 within the operation groove 13 to adjust the position of the connecting arm 20 on the grip body 10.

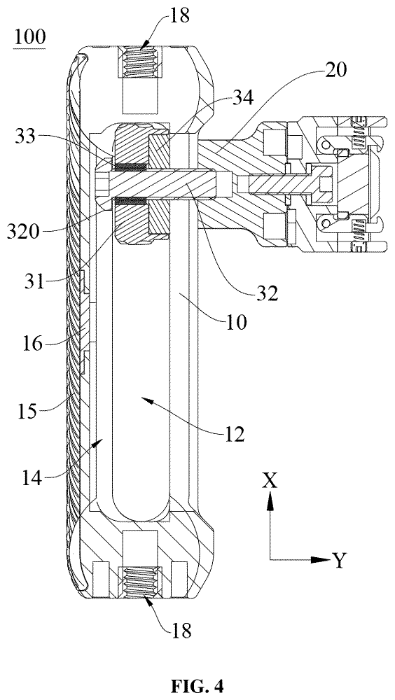

Taking the example of the locking member 31 with a knob structure, FIG. 4 elaborates on the specific structure of the locking component 30. As depicted in FIG. 2, the locking component 30 may additionally include a first threaded rod 32. One end of the first threaded rod 32 connects to the connecting arm 20, while the other end passes through the grip body 10 and threadedly connects to the locking member 31.

The threaded connection between the locking member 31 and the first threaded rod 32 enables the connecting arm 20 to slide on the grip body 10 for position adjustment when the locking member 31 is unscrewed or loosened. Tightening the locking member 31 secures the connecting arm 20 to the side wall of the grip body 10 in the Y-direction, thus fixing the connecting arm 20 to the grip body 10. The first threaded rod 32 can be a screw or a threaded stud, and its connection to the connecting arm 20 can be achieved through bonding, pinning, or other methods. The present disclosure does not imply any specific structure of the first threaded rod 32 or its connection method to the connecting arm 20.

Furthermore, FIG. 4 shows that the locking component 30 may also include a brace 33. Positioned between the locking member 31 and the first threaded rod 32, the brace 33 connects to the locking member 31 and facilitates the threaded connection to the first threaded rod 32.

By threading the locking member 31 to the first threaded rod 32 through the brace 33, direct friction between the locking member 31 and the first threaded rod 32 during rotation can be prevented, thereby prolonging the service life of the locking member 31. The brace 33 can be positioned either through the locking member 31 along the Y-direction or near the locking member 31, adjacent to the connecting arm 20 along the Y-direction. The exact position of the brace 33 is not restricted in this disclosure. Additionally, the connection between the brace 33 and the locking member 31 can be achieved through bonding, interference fit, riveting, or other methods, with no specific restrictions imposed hereinafter.

To secure the brace 33, FIG. 4 illustrates that the locking component 30 (depicted in FIG. 2) may further include a retention collar 34 connected to the locking member 31. One end of the first threaded rod 32 features a nut 320 outside the locking member 31, while the other end passes through the locking member 31 and the retention collar 34 to connect with the connecting arm 20. The brace 33 is situated between the retention collar 34 and the nut 320.

In some aspects, the retention collar 34 and the nut 320 jointly restrict the brace 33 in the Y-direction, preventing detachment from the locking member 31. The retention collar 34 can be a ball bearing, with the outer ring connected to the inside wall of the locking member 31 and the first threaded rod 32 passing through the inner ring. This design ensures smoother rotation of the locking member 31 and enhances the tactile experience. Alternatively, the retention collar 34 can be made of other materials, such as a rubber ring, without specific restrictions on the structure.

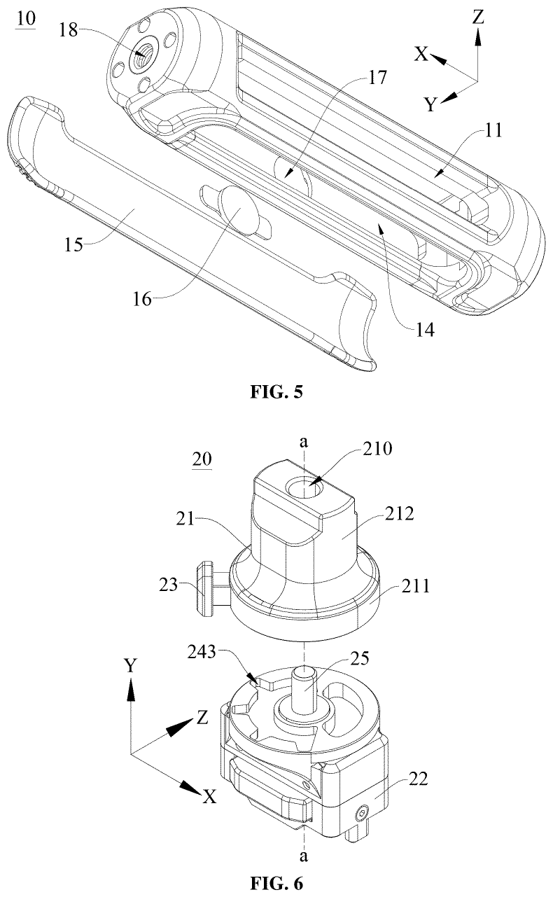

According to the aforementioned aspects, when the first threaded rod 32 is a screw with a nut 320, as shown in FIGS. 4 and 5, the inner side wall of the grip body 10 can feature an avoidance groove 14 along the sliding path (X-direction) of the first threaded rod 32. A gap exists between the inside wall of the avoidance groove 14 and the nut 320.

When the first threaded rod 32 is a screw with a nut 320, by incorporating the avoidance groove 14 on the inside wall of the grip body 10 and maintaining a gap between the inside wall and the nut 320, the grip body 10 is protected from scratches during the sliding of the nut 320, thereby extending the service life of the grip body 10. Additionally, the avoidance groove 14 provides space for the nut 320 to move, preventing jamming issues caused by friction between the nut 320 and the grip body 10 while the first threaded rod 32 is sliding.

Moreover, FIGS. 4 and 5 show that the camera grip 100 can include a non-slip gasket 15 and a seal sheet 16. The grip body 10 features a mounting hole 17. Through the mounting hole 17, the first threaded rod 32 is installed into the accommodating chamber 12. The seal sheet 16 seals the mounting hole 17, and the non-slip gasket 15 connects to the grip body 10, covering the seal sheet 16.

For screws paired with nuts 320, a mounting hole 17 is created on the grip body 10 to facilitate the installation of screws into the accommodating chamber 12. Subsequently, the mounting hole 17 can be sealed with a seal sheet 16, preventing the screws from dislodging from the accommodating chamber 12. The non-slip gasket 15 can be affixed to the grip body 10 through adhesion, screwing, or alternative methods. This not only enhances the friction for the photographer when gripping, thereby improving the gripping experience, but also conceals the seal sheet 16, preserving the aesthetic appeal of the grip body 10.

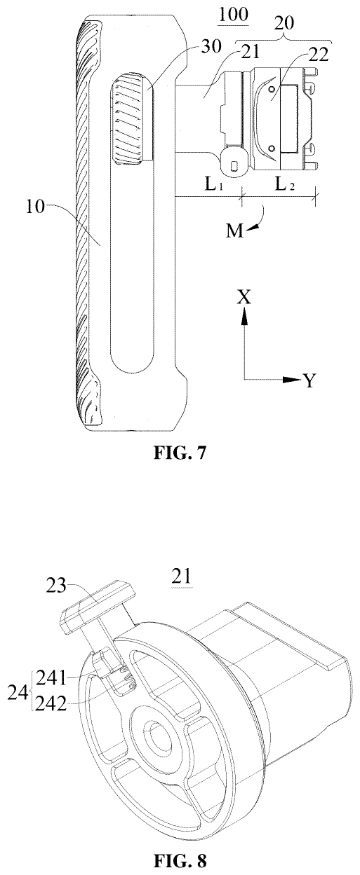

In further aspects, as depicted in FIGS. 6 and 7, at least one end of the grip body 10 may feature an extension interface 18, enabling the connection of camera accessories 200.

Camera accessories 200, including tripods, hand straps, extension poles, and flashes, can be linked to the grip 10 via the extension interface 18. The extension interface 18 may manifest as a physical interface, such as a threaded, clamping, or plug-in interface, or as an electrical interface, like a power or signal interface. The present disclosure imposes no restrictions on the position or type of the extension interface 18.

The aforementioned aspects elaborate on the specific structures of the grip body 10 and the locking component 30 within the camera grip 100. To facilitate photographers in adjusting the shooting device 2 according to their needs, the present disclosure introduces a thoughtfully designed connecting arm 20. The following aspects delve into the specific structure of the connecting arm 20. As illustrated in FIGS. 6 and 7, the connecting arm 20 includes a connector 21 and a detachable member 22. The connector 21 features a first end and a second end, positioned opposite each other. The first end of the connector 21 connects to the grip body 10, while the second end is distant from the grip body 10. The detachable member 22 connects to the connector 21 and can rotate and lock relative to the connector 21, enabling connection to the shooting device 2 (depicted in FIG. 1).

For instance, the connector 21 and the detachable member 22 can connect along the Y-direction and rotate relative to each other within the XZ plane. Photographers can freely adjust the rotation angle of the shooting device 2 to better frame shots during tilt or underslung grip shooting, while also holding the grip body 10 comfortably to suit personal preferences. Along the Y-direction, one end of the connector 21 can include a connecting hole 210 for attaching to the first threaded rod 32 mentioned in previous aspects. Moreover, based on the shape of the slide groove 111 on the grip body 10, the end of the connector 21 with the connecting hole 210 can be designed as a wedge, allowing the connector 21 to partially extend into the slide groove 111 and slide, thus preventing easy detachment from the grip body 10.

Existing camera grips place the rotating mechanism inside the grip body to adjust the rotation angle for the shooting device 2. However, prolonged use can lead to loosening, deformation, or wear of the internal rotating mechanism. In present disclosure, since the second end of the connector 21 is distant from the grip body 10, the connection between the connector 21 and the detachable member 22 is located outside the grip body 10. When the distance between the shooting device 2 and the grip body 10 remains constant, this application ensures a distance of L2 between the shooting device 2 and the rotating mechanism, compared to the conventional distance of L1+L2. Clearly, the distance in this application is shorter. According to the lever principle, with a constant gravity of the shooting device 2, the torque M between the connector 21 and the detachable member 22 is reduced. Therefore, while enabling adjustable rotation angles for the shooting device 2, the present disclosure also decreases the torque M between the connector 21 and the detachable member 22, mitigating issues like loosening, deformation, or wear inside the grip body 10 and extending the service life of the camera grip 100.

Moreover, situating the connection between the connector 21 and the detachable member 22 outside the grip body 10 eliminates the need for placing rotating structure related components inside the grip body 10, conserving internal space. This facilitates designing the grip 10 to better accommodate the photographer's palm or directly reducing the size of the grip 10.

In some aspects, as shown in FIGS. 6 and 8, the connecting arm 20 may also include a limiting button 23 and a limiting assembly 24. The limiting assembly 24 can be situated between the connector 21 and the detachable member 22, with the limiting button 23 exposed on the exterior of the connecting arm 20 and connected to the limiting assembly 24. The limiting button 23 can control the unlocking of the limiting assembly 24, enabling the connector 21 and the detachable member 22 to rotate relative to each other. Further, it can control the locking of the limiting assembly 24, fixing the connector 21 and the detachable member 22 in place.

By positioning the limiting button 23 and the limiting assembly 24 on the connecting arm 20, photographers can secure the shooting device 2 at a predetermined rotation angle by pressing the limiting button 23. This facilitates fixed-angle shooting and offers a more streamlined operation. The limiting assembly 24 can manifest as a limiting latch, an end cam, or other configurations, with no restrictions on the specific structure of the limiting assembly 24 in this disclosure.

In some aspects, as illustrated in FIGS. 6 and 8, the limiting assembly 24 includes a limiting part 241 and an elastic member 242. One of the connector 21 or the detachable member 22 features at least one limiting groove 243, while the limiting button 23 is mounted on the other and linked to the limiting part 241. The limiting button 23 enables the limiting part 241 to be disengaged from the limiting groove 243, and the elastic member 242 facilitates the resetting of the limiting part 241.

For instance, the limiting groove 243 can be positioned on the detachable member 22, with the limiting button 23 on the connector 21. To adjust the rotation angle of the shooting device 2, pressing the limiting button 23 allows the limiting part 241 to exit or disengage the limiting groove 243, enabling relative rotation between the connector 21 and the detachable member 22. Conversely, to fix the rotation angle, the limiting part 241 resets into or engage the limiting groove 243 under the elastic force of the elastic member 242, thereby preventing relative rotation between the connector 21 and the detachable member 22.

Alternatively, the limiting groove 243 can be placed on the connector 21, with the limiting button 23 on the detachable member 22. Positioning the limiting button 23 on the connector 21 prevents the limiting button 23 from rotating with the detachable member 22, negating the need for rotation of the finger while pressing the limiting button 23. There are no restrictions on the specific placement of the limiting groove 243 and the limiting button 23. The elastic member 242 can be a spring, a spring plate, or other configurations, with no restrictions on the specific structure of the elastic member 242.

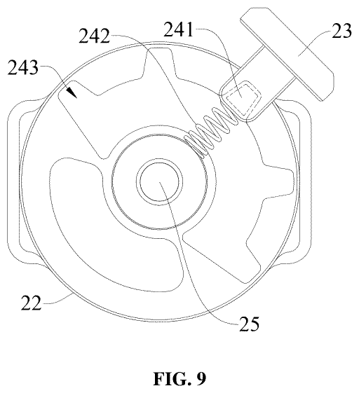

In some aspects, as depicted in FIG. 9, the limiting button 23 is mounted on the connector 21 (FIG. 8) and capable of radial movement relative to the connector 21. The elastic member 242 can be installed inside the connector 21 along the radial direction of the connector 21, with two ends connected to the limiting button 23 and the connector 21, respectively. The limiting groove 243 is positioned inside the detachable member 22 along the radial direction of detachable member 22, with the limiting part 241 disposed within the limiting groove 243 and capable of radial movement relative to the detachable member 22. Pressing the limiting button 23 towards the connector 21 causes the limiting part 241 to slide out of the limiting groove 243, while moving the limiting button 23 away from the connector 21 allows the elastic member 242 to reset the limiting part 241.

Pressing the limiting button 23 compresses the elastic member 242 along the radial direction of the connecting arm 20, causing the limiting part 241 to exit the limiting groove 243. This radial pressing of the limiting button 23 along the connecting arm 20 facilitates easy finger operation. Alternatively, arranging the elastic member 242 along the axial direction of the connecting arm 20 enables an axial toggling operation mode for the limiting button 23. However, compared to radial pressing, axial toggling involves a longer finger movement, potentially causing fatigue. There are no restrictions on the operation mode of the limiting button 23 in this application.

Furthermore, as shown in FIG. 9, multiple limiting grooves 243 can be arranged circumferentially on the connector 21 or detachable member 22. This allows the limiting part 241 to achieve multi-angle adjustment of the shooting device 2 by engaging different limiting grooves 243. For example, for a 180° switch from overhead to upward shooting, the limiting grooves 243 can be spaced half a circle apart along either the connector 21 or the detachable member 22. Alternatively, limiting grooves 243 can be spaced a full circle apart. There are no specific restrictions on the number and spacing of the limiting grooves 243 in this application.

In certain aspects, as depicted in FIG. 6, the connecting arm 20 may additionally incorporate a second threaded rod 25, with the axial direction a-a of the second threaded rod 25 positioned centrally between the connector 21 and the detachable member 22. The connector 21 is rotatably interconnected with the detachable member 22 via the second threaded rod 25.

In these configurations, the second threaded rod 25 can be either a screw or a stud, enabling the connector 21 and the detachable member 22 to be threadably engaged with the second threaded rod 25. This not only facilitates the connection between the connector 21 and the detachable member 22 but also permits relative rotation between the connector 21 and the detachable member 22. Alternatively, in other aspects, the second threaded rod 25 may be a pivot pin, allowing the connector 21 and the detachable member 22 to be connected to the pivot pin with restraint. No specific constraints are imposed on the structure of the second threaded rod 25 in this disclosure.

Moreover, as illustrated in FIG. 6, the connector 21 includes a first connecting end 211 proximate to the detachable member 22 and a second connecting end 212 proximate to the grip body 10. The caliber (e.g., thickness or diameter) of the first connecting end 211 may be larger than the caliber of the second connecting end 212, with a curved transition (e.g., a smooth curved or filleted surface) between the first connecting end 211 and the second connecting end 212.

Increasing the caliber of the first connecting end 211 relative to the second connecting end 212 enhances the structural strength of the connector 21, thereby improving the load-bearing capacity and ensuring the stability of the connection. The curved transition between the first connecting end 211 and the second connecting end 212 also minimizes discomfort when gripped by the photographer.

The aforementioned description utilizes specific examples to elucidate the camera auxiliary device, solely for the purpose of facilitating understanding and not for imposing limitations. Those skilled in the relevant technical field can make simple deductions, modifications, or substitutions based on the concept of the utility model.

What is claimed is:

1. A camera grip, comprising:
a grip body comprising a guide rail;
a connecting arm comprising a first end slidably engaged with the guide rail and a second end configured for coupling with a shooting device; and
a locking component connected to the first end of the connecting arm,
wherein an unlocked state of the locking component permits a sliding movement of the connecting arm along the guide rail, and a locked state of the locking component fixes the connecting arm on the guide rail.

2. The camera grip according to claim 1, wherein the guide rail comprises a sliding channel provided on the grip body;
wherein the first end of the connecting arm is configured to slide within the sliding channel; and
wherein the locking component comprises a locking member connected with the first end of the connecting arm, and the locking member is configured to control transition of the locking component between the locked state and the unlocked state.

3. The camera grip according to claim 2, wherein the locking component further comprises a first threaded rod; and
wherein a first end of the first threaded rod is connected to the connecting arm and a second end of the first threaded rod extends through the grip body and threadably engages with the locking member.

4. The camera grip according to claim 3, wherein the locking member comprises a brace;
wherein the brace is interposed between the locking member and the first threaded rod; and
wherein the locking member engages with the first threaded rod threadably via the brace.

5. The camera grip according to claim 4, wherein the locking component further comprises a retention collar secured to the locking member;
wherein a first end of the first threaded rod comprises a nut positioned externally to the retention collar;
wherein a second end of the first threaded rod traverses the locking member and the retention collar and is connected with the connecting arm; and
wherein the brace is constrained between the retention collar and the nut.

6. The camera grip according to claim 3, wherein the grip body further comprises a non-slip gasket and a seal sheet;
wherein the grip body further comprises an accommodating chamber and a mounting hole communicating with the accommodating chamber;
wherein the first threaded rod extends into the accommodating chamber through the mounting hole; and
wherein the seal sheet is compression-fitted within the mounting hole and the non-slip gasket overlies the seal sheet and is connected with the grip body.

7. The camera grip according to claim 1, wherein the connecting arm comprises a connector and a detachable member;
wherein the connector comprises a first end and a second end positioned opposite to each other;
wherein the first end of the connector connects to the grip body, and the second end of the connector is distant from the grip body;
wherein the detachable member attaches to the connector and is configured to rotate relative to the connector and lock in place; and
wherein the detachable member is configured to connect to the shooting device.

8. The camera grip according to claim 7, wherein the connecting arm further comprises a limiting button and a limiting assembly;
wherein the limiting assembly is provided between the connector and the detachable member;
wherein the limiting button is exposed outside the connecting arm, and is connected to the limiting assembly; and
wherein the limiting button is configured to selectively control the limiting assembly between:
an unlocked state, enabling relative rotation between the connector and the detachable member; and
a locked state, securing the connector and the detachable member in a fixed position.

9. The camera grip according to claim 7, wherein the limiting assembly comprises a limiting part and an elastic member;
wherein one of the connector and the detachable member is provided with at least one limiting groove, and the limiting button is disposed on the other one of the connector and the detachable member, and the limiting button is connected to the limiting part; and
wherein the limiting button is configured to control the limiting part to slide out of the at least one limiting groove, and the elastic member facilitates resetting of the limiting part.

10. A camera auxiliary device, comprising:
the camera grip as specified in claim 1; and
a camera accessory connected to the camera grip.
